(19) United States
(12) Patent Application Publication
(10) Pub. No.: US 2012/0230251 A1
(43) Pub. Date: Sep. 13, 2012

(54) Method for controlling devices through electric power transmission line based network

(76) Inventor: Ming-Wei Lu, Taipei (TW)

(21) Appl. No.: 13/044,569

(22) Filed: Mar. 10, 2011

(51) Int. Cl. H04W 4/00

(52) U.S. Cl. 370/328

(57) ABSTRACT

A control method for an electric power transmission line based network including network sections each having a monitor and at least one device group, each device group having at least one input device and at least one output device, each input or output device having a set switch comprising transmitting a packet from one device to another device of the same device group over the network section containing the device group wherein the set switch of the device may set itself to belong to one device group, all devices have a right of controlling the network with different priorities, the packet transmission is performed after the device transmitting the packet having controlled the network if the priority thereof is the highest among the activated devices, and the remaining devices in the same network section may read the packet.

### BACKGROUND OF THE INVENTION

1. Field of the Invention

The invention relates to data communications and more particularly to a method for controlling input and output devices through an electric power transmission line based network.

2. Description of Related Art

Conventionally, two computers may effect data communications therebetween via a communications link. The data communications is a client-server model and is carried out by polling and handshake as known in the art. It is required that all computers connected to the Internet to be verified. However, it is a time consuming procedure. Further, a next computer is required to wait for check before a previous computer has finished the data communications. Hence, its performance is lowered greatly if there are many computers connected to the Internet. It is clearly that the conventional data communications method is not suitable for a communications link across overhead power lines because data is sent in a lower rate over the electric power transmission line. Thus, the need for improvement still exists.

### SUMMARY OF THE INVENTION

It is therefore one object of the invention to provide a control method for an electric power transmission line based network including a plurality of wire connected network sections each having a monitor and at least one device group, each device group having at least one input device and at least one output device, each input device having a set switch, and each output device having a set switch, comprising the steps of transmitting a packet from one input device or output device to another device of the same device group over the network section containing the device group wherein the set switch of the input device or the output device is adapted to set itself to belong to one device group, all of the input devices and the output devices have a right of controlling the electric power transmission line based network with different priorities, the packet transmission is performed after the input device or the output device transmitting the packet having controlled the electric power transmission line based network if the priority thereof is the highest among the activated input devices and the output devices, and the remaining devices other than the input device or the output device transmitting the packet in the same network section are adapted to read data of the packet.

The above and other objects, features and advantages of the invention will become apparent from the following detailed description taken with the accompanying drawings.

### BRIEF DESCRIPTION OF THE DRAWINGS

FIG. 1 presents schematically an electric power transmission line based network applicable for a preferred embodiment of the invention;

FIGS. 2 and 3 are block diagrams of the input device and output device respectively;

FIGS. 4 and 5 present schematically transmission of packet in the network section; and

FIG. 6 presents schematically wire connection of the network section to the Internet and wireless connection of the network section to the cellular network.

### DETAILED DESCRIPTION OF THE INVENTION

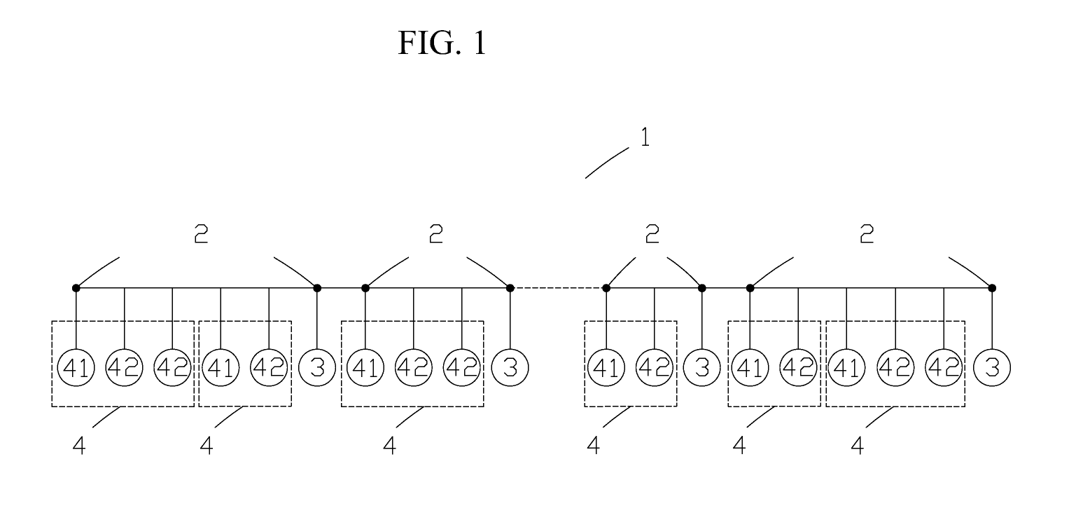

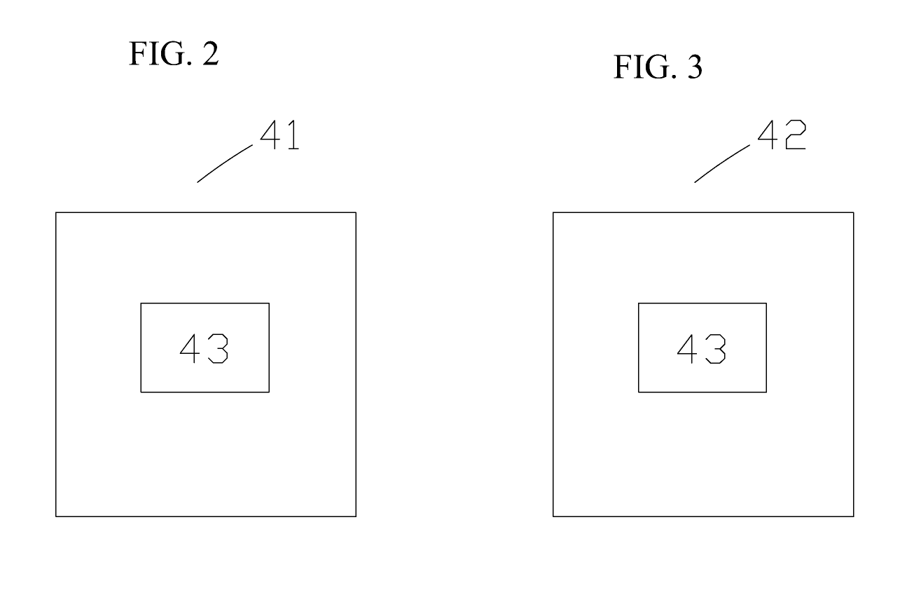

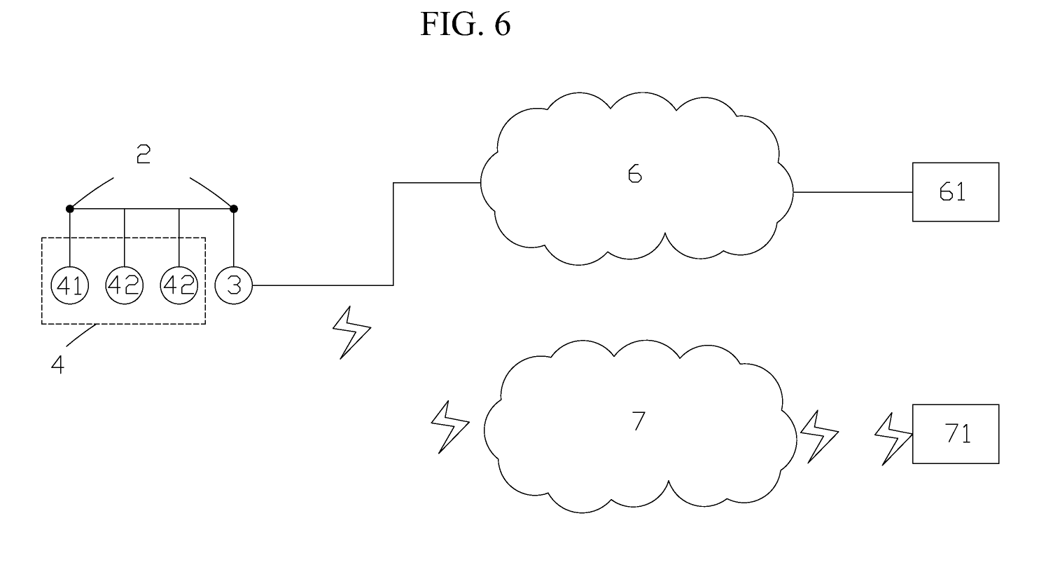

Referring to FIGS. 1 to 6, a method for controlling devices through electric power transmission line based network 1 in accordance with a preferred embodiment of the invention is illustrated below.

The electric power transmission line based network 1 may control devices connected thereto. A plurality of input devices 41, a plurality of output devices 42, and a plurality of monitors 3 are adapted to connect to the electric power transmission line based network 1. The electric power transmission line based network 1 comprises a plurality of network sections 2. The input devices 41 and the output devices 42 are connected to the electric power transmission line based network by wire for data communications among them. Each network section 2 has at least one device group 4 each having at least one input device 41 and at least one output device 42. Each of the input device 41 and the output device 42 has a set switch 43. The monitors 3 are connected to the electric power transmission line based network by wire for data communications among them.

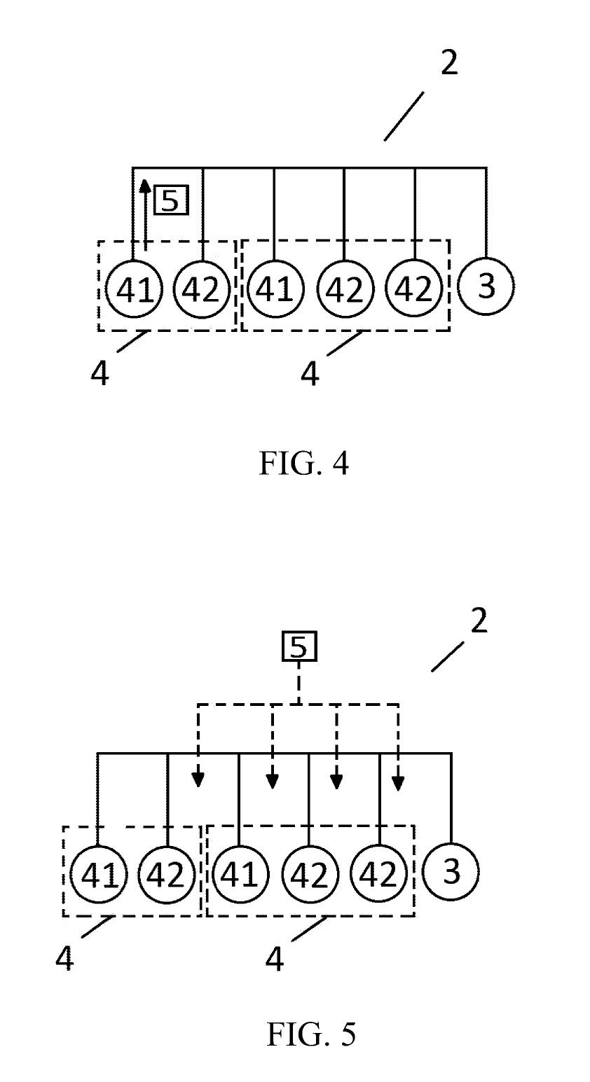

The method of the invention is further described below. In FIG. 4, for example, a packet 5 can be transmitted from one input device 41 to the other output device 42 of the same device group 4 over the network section 2. Alternatively, the same packet 5 can be transmitted to any of the input device 41 and the output devices 42 in another device group 4 over the network section 2. The set switch 43 in the input device 41 (or the output device 42) can be operated to set the input device 41 (or the output device 42) to belong to a specific device group 4. As shown in FIG. 4, the network section 2 comprises two device groups 4 each including an input device 41 and an output device 42 (or an input device 41 and two output devices 42).

For transmitting the packet 5 from one input device 41 to another input device 41 (or the output device 42) over the network section 2, it is required to obtain the control of the network. All input devices 41 and output devices 42 in the network section 2 have the right of controlling the network but with different priorities. Thus, the input device 41 or the output device 42 having the highest priority may obtain the control of the network. In addition, all input devices 41 and output devices 42 in the network section 2 may read data of the packet 5 being transmitted over the network section 2.

The method of the invention is further described below. In control mode 1, an input device 41 of the device group 4 in the network section 2 may set the status of an output device 42 of the same device group 4 by utilizing the transmission of the packet 5 over the network section 2. As a result, the status of the output device 42 is changed (i.e., updated).

The method of the invention is further described below. In control mode 2, an input device 41 of the device group 4 in the network section 2 may set the status of an output device 42 of the same device group 4 by utilizing the transmission of the packet 5 over the network section 2. As a result, the status of the output device 42 is changed. Moreover, all input devices 41 in the network section 2 may update a network equipment status table stored in itself by utilizing the transmission of the packet 5 over the network section 2, and all output devices 42 in the network section 2 may update a network equipment status table stored in itself by utilizing the transmission of the packet 5 over the network section 2. Thus, data in the network equipment status tables of all input devices 41 and output devices 42 are updated.

In the same device group 4, the input device 41 may change data in the network equipment status table of the output device 42 if such need arises. Also, data is communicated by transmitting the packet 5 over the network section 2. In addition, all other input devices 41 in the network section 2 may update the network equipment status table stored in itself by utilizing the transmission of the packet 5 over the network section 2, and all other output devices 42 in the network section 2 may update the network equipment status table stored in itself by utilizing the transmission of the packet 5 over the network section 2. For an output device 42, after updating the network equipment status table thereof, the output device 42 may set the network equipment status table thereof based on the update. Hence, the current status of the output device 42 can be updated based on data in the network equipment status table thereof.

The method of the invention is further described below. In check mode 1, in the network section 2 all input devices 41 and output devices 42 can communicate one another by transmitting the packet 5 over the network section 2. This has the effect of checking the network equipment status tables stored in the input devices 41 and the output devices 42 in order to determine whether data in the network equipment status table has been updated (i.e., correct data).

In detail, the input device 42 (or the output device 43) may transmit the packet 5 containing the network equipment status table stored therein over the network section 2 in a specific time. Thus, in the same network section 2 the remaining input devices and output devices 42 can communicate one another by reading the network equipment status table in the packet 5 transmitted over the network section 2. This has the effect of checking the network equipment status tables stored in the input devices 41 and the output devices 42 in order to determine whether data in the network equipment status table has been updated (i.e., correct data). To the contrary, a warning sound, flash of light, or alert message may be shown for warning or alerting users.

The monitor 3 in the network section 2 may be activated to transmit a signal of warning to each of the input devices 42 and the output devices 43 in the network section 2 if such discrepancy occurs. In detail, the warning signal may be sent from the monitor 3 to a remote computer 61 over the Internet 6 or to a mobile phone 71 by connecting to a cellular network 7. Thus, a trouble shooting employee may be informed by the warning signal.

The method of the invention is further described below. In check mode 2, in the network section 2 all input devices 41 and output devices 42 are allowed to sequentially execute the check mode 1 based on its priority of network control if all of the input devices 41 and the output devices 42 are neither in the control modes 1 and 2 nor in the check mode 1.

The method for controlling devices through electric power transmission line based network of the invention can be summarized below. A packet is used to transmit data of small size. Hence, it is possible of controlling a network including a plurality of connected network sections through electric power transmission lines. This has the advantages of increasing data transmission rate among devices (e.g., computers) connected to the network, interference elimination, more fault tolerant, and increased reliability. The invention is particularly to intranet installed in a building, traffic control, or the like.

It is further envisaged by the invention that all devices connected to the network section may check the network equipment status thereof in order determine whether it has been updated or not by transmitting a packet over the network section and executing both the control mode and the check mode. The updating function also can check whether there is any device added to or removed from the network. Thus, a user or a monitor may be informed of the same.

While the invention has been described in terms of preferred embodiments, those skilled in the art will recognize that the invention can be practiced with modifications within the spirit and scope of the appended claims.

What is claimed is:

1. A control method for an electric power transmission line based network including a plurality of wire connected network sections each having a monitor and at least one device group, each device group having at least one input device and at least one output device, each input device having a set switch, and each output device having a set switch, comprising the steps of:
transmitting a packet from one input device or output device to another device of the same device group over the network section containing the device group wherein the set switch of the input device or the output device is adapted to set itself to belong to one device group, all of the input devices and the output devices have a right of controlling the electric power transmission line based network with different priorities, the packet transmission is performed after the input device or the output device transmitting the packet having controlled the electric power transmission line based network if the priority thereof is the highest among the activated input devices and the output devices, and the remaining devices other than the input device or the output device transmitting the packet in the same network section are adapted to read data of the packet.

2. The control method of claim 1, further comprising performing a first control mode of causing one of the at least one input device of the device group in the network section to update a network equipment status of one of the at least one output device of the same device group via the packet transmission.

3. The control method of claim 1, further comprising performing a second control mode of causing one of the at least one input device of the device group in the network section to update a network equipment status of one of the at least one output device of the same device group via the packet transmission, and causing the one of the at least one input device of the device group in the network section to update a network equipment status of each of the remaining devices of the same device group via the packet transmission.

4. The control method of claim 3, wherein the input device is adapted to update the network equipment status of each of the at least one output device of the same device group by transmitting the packet over the network section, and wherein each of the remaining devices other than the input device transmitting the packet in the same network section is adapted to read data of the packet for updating the network equipment status thereof.

5. The control method of claim 1, further comprising performing a first check mode of causing all of the devices in the same network section to communicate one another by transmitting the packet over the network section for checking whether the network equipment status of each of the at least one input device and the at least one output device has been updated.

6. The control method of claim 5, wherein the input device or the output device transmits the packet containing the network equipment status table thereof over the network section in a preset time, and wherein in the same network section the remaining devices can communicate one another by reading the network equipment status in the packet for checking whether the network equipment status of each of the remaining devices has been updated, the control method further comprising issuing warning in a form of audio and/or video if there is a discrepancy as a result of the checking.

7. The control method of claim 1, further comprising performing a second check mode of causing all of the devices in the network section to sequentially execute the first check mode based on its priority of the right of controlling the electric power transmission line based network if all of the devices are neither in the first and second control modes nor in the first check mode.

8. The control method of claim 6, wherein each of the network sections has a monitor connected thereto, and wherein in response to the discrepancy the monitor is adapted to transmit a warn signal to each device in the network section and transmit the warning signal to a remote computer over the Internet or to a mobile phone by connecting to a cellular network.
